(19) United States
(12) Patent Application Publication
(10) Pub. No.: US 2020/0010188 A1
(43) Pub. Date: Jan. 9, 2020

(54) AIRCRAFT

(71) Applicant: Dr. Ing. h.c. F. Porsche Aktiengesellschaft, Stuttgart (DE)

(72) Inventor: Mikel Fauri, Ludwigsburg (DE)

(73) Assignee: Dr. Ing. h.c. F. Porsche Aktiengesellschaft, Stuttgart (DE)

(21) Appl. No.: 16/502,320

(22) Filed: Jul. 3, 2019

(30) Foreign Application Priority Data
Jul. 4, 2018 (DE) 102018116148.4

(51) Int. Cl. B64C 29/00; B64C 3/54; B64D 27/24; B64C 11/00; B64C 11/46

(52) U.S. Cl. CPC B64C 29/0033; B64C 3/546; B64C 39/10; B64C 11/001; B64C 11/46; B64D 27/24

(57) ABSTRACT

An aircraft includes cruise propellers, lifting propellers, an energy battery and a power battery. The energy battery is electrically connected to the cruise propellers, and the power battery is electrically connected to the lifting propellers.

### CROSS-REFERENCE TO RELATED APPLICATION

This application claims priority to German Patent Application No. 10 2018 116 148.4, filed Jul. 4, 2018, the content of such application being incorporated by reference herein in its entirety.

### FIELD OF THE INVENTION

The present invention relates to an aircraft, in particular a fully electric vertical take-off and landing (VTOL) aircraft.

### BACKGROUND OF THE INVENTION

VTOL is the cross-language name given in the aerospace industry to any type of aircraft, drone or rocket that has the capability of lifting off and landing substantially vertically and without a runway. This collective term is used below in a broad sense that includes not just fixed-wing aircraft with wings, but rather also rotary-wing aircraft such as helicopters, gyrocopters, gyrodynes and hybrids such as composite or combination helicopters and convertiplanes. Short take-off and landing (STOL) aircraft, short take-off and vertical landing (STOVL) aircraft and vertical take-off and horizontal landing (VTHL) aircraft are also included.

CN106981914A, which is incorporated by reference herein, discloses a vehicle-assisted energy control method and system based on two batteries. In this case, the vehicle switches between a normal mode, a recovery mode, a reserve battery charging mode or an isolation mode depending on the vehicle state, wherein the vehicle load is supplied with current by a first battery in the normal mode, the vehicle load, the first battery and the second battery are simultaneously charged by a current generator in the recovery mode, the second battery is charged by the power generator in the reserve battery charging mode and the power is fed to the vehicle load by the first battery and to a starter motor by the second battery in the isolation mode. The batteries are thus intended to be efficiently charged and discharged over the entire operating cycle in accordance with various power requirements under different operating conditions.

EP2592686B1, which is incorporated by reference herein, describes a control system for controlling the operation of a storage battery, coupled to an energy grid, having a plurality of storage batteries arranged in an energy grid and a control device that defines an individual charge or discharge rate for the respective storage batteries using a requirement prediction on the basis of battery state and energy supply.

DE4118594C1, which is incorporated by reference herein, proposes, for an electric vehicle, the combination of a high-power battery having a relatively high specific energy content, for example a nickel/cadmium or sodium/sulfur or zinc/bromine battery, as a large energy store with a smaller battery of the same voltage having a smaller specific energy content, but a relatively high power in relation to its weight and a considerably lower price/performance ratio, for example a lead gel or lead acid battery.

### SUMMARY OF THE INVENTION

Described herein is a fully electric vertical take-off and landing aircraft. The aircraft comprises cruise propellers, lifting propellers, an energy battery and a power battery. The energy battery is electrically connected to the cruise propellers and the power battery is electrically connected to the lifting propellers.

Particular benefits of this aircraft lie in the low installation space and weight of the battery system of an aircraft according to aspects of the invention.

The aircraft may thus be equipped for instance with bent or even selectively bendable wings. A corresponding variant increases the effective wing surface in horizontal flight, without however increasing the footprint of the aircraft.

The aircraft may furthermore have a fast-charging battery system that provides the drive energy for vertical take-off and landing and horizontal flight and allows quick charging of the aircraft when stationary.

In this case, instead of free-moving rotors, a plurality of ducted fans, including of different sizes, may be used to drive the aircraft, as are known outside of the aerospace industry, for instance for hovercraft or fanboats. The cylindrical housing surrounding the fan may considerably reduce thrust losses caused by vortexes at the blade tips in such an embodiment. Suitable ducted fans may be aligned horizontally or vertically, designed so as to pivot between both positions or be covered by louvers during horizontal flight for aerodynamic reasons. Pure horizontal thrust generation using fixed ducted fans is additionally conceivable.

Finally, in addition to preferably fully autonomous operation of the aircraft, it is also possible to consider granting manual control to human pilots if they are sufficiently qualified, which gives the device according to aspects of the invention the greatest possible flexibility in terms of handling.

### BRIEF DESCRIPTION OF THE DRAWING

One exemplary embodiment of the invention is illustrated in the drawing and is described in more detail below.

FIG. 1 shows the greatly simplified block diagram of an aircraft.

FIG. 2 depicts an isometric view of an aircraft, wherein the wings are shown in an extended configuration and the rear propellers are shown in an angled orientation.

FIG. 3 depicts a front elevation view of the aircraft of FIG. 2, wherein the wings are shown extended configuration and the rear propellers are shown in a cruising orientation.

FIG. 4 depicts another front elevation view of the aircraft, wherein the wings are shown in a folded configuration and the rear propellers are shown in a take-off/landing orientation.

FIG. 5 depicts a top plan view of a portion of an aircraft, showing an internal duct extending between a nose of the aircraft and a horizontal fan mounted to the wing.

FIG. 6 depicts moveable louvers applied on top of the horizontal fan of FIG. 5, wherein the louvers are shown in a closed position.

FIG. 7 depicts the movable louvers of FIG. 6, wherein the louvers are shown in an open position.

### DETAILED DESCRIPTION OF THE INVENTION

The terms ‘fan’, ‘rotor’ and ‘propeller’ may be used interchangeably herein.

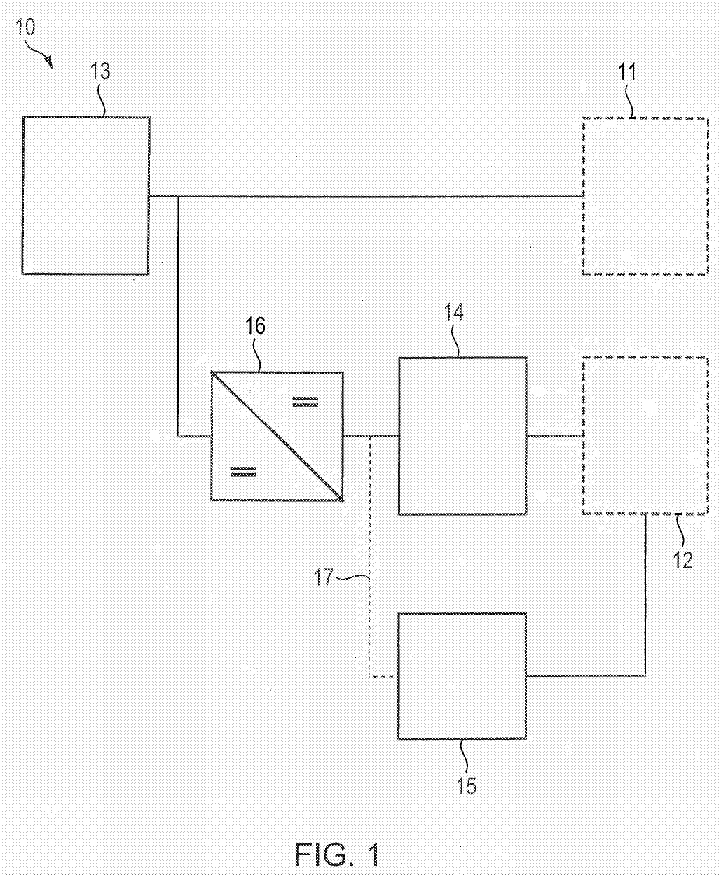

FIG. 1 schematically illustrates the structural features of one preferred configuration of the aircraft 10 according to aspects of the invention, whose hybrid battery system 13, 14, 15 is visibly divided into a plurality of sub-batteries adapted to the various flight phases. An energy battery 13, designed with the greatest possible energy density, is in this case used to drive the cruise propeller, while a power battery 14 that is optimized in terms of short-term power output and is assisted by a reserve battery 15 connected in parallel when needed supplies the lifting propellers 12 that are used in particular for take-off and landing.

A suitably dimensioned DC voltage converter 16 connects the energy battery 13 in the present configuration to the power battery 14 and reserve battery 15 such that said power battery and reserve battery are able to be recharged by the energy battery 13 during cruising. In the meantime, it is understood that the electrical connection, provided with the reference sign 17, may be dispensed with in an alternative embodiment, provided that it does not appear necessary to recharge the reserve battery 15 during the flight.

FIGS. 2-4 depict an aircraft 100. The aircraft 100 shown in those figures may appear different from the previously described aircraft, however, most (if not all) of the details of the previously described aircraft also apply to aircraft 100.

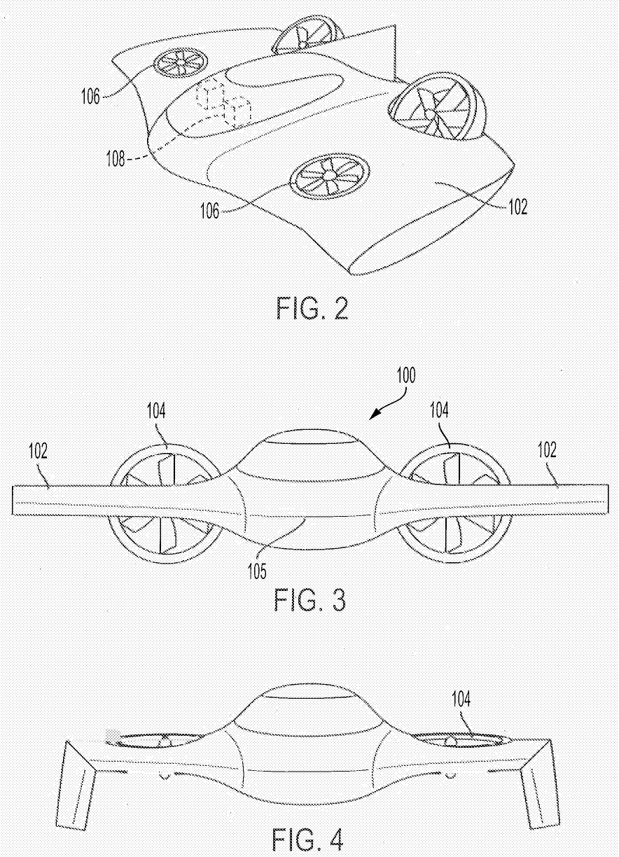

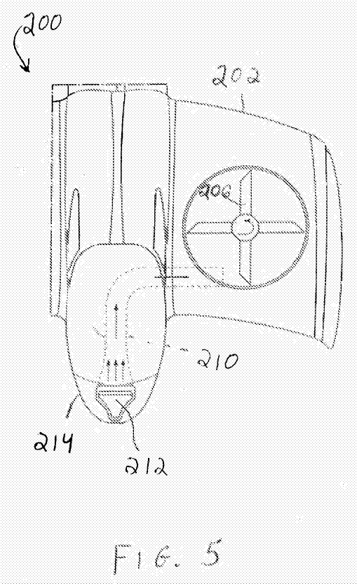

The aircraft 100 includes foldable wings 102. The wings 102 are shown in a folded configuration in FIG. 4 and an extended configuration in FIG. 3. A motor or solenoid is configured to move the wings between those configurations. Alternatively, the wings 102 may be permanently positioned in the folded configuration, and referred to herein as “bent.”

Rear propellers 104 are mounted on the trailing edge of the airfoils or wings 102 (i.e., the edge furthest from the nose 105). Propellers 104 may be referred to as cruising propellers because they are used during the cruising operation of the aircraft (at least in one position of the propellers 104). The propellers 104 are configured to pivot between two different positions, as shown in FIGS. 2-4. In the vertical position of the propellers 104 shown in FIG. 3, the propellers 104 generate maximum horizontal thrust for cruising operation of the aircraft (i.e., while the aircraft is flying through the air). In the horizontal position of the propellers 104 shown in FIG. 4, the propellers 104 generate maximum vertical thrust for take-off and landing operations of the aircraft. A motor or solenoid is configured to move the propellers 104 between those two positions. Alternatively, the propellers 104 may be immovable and fixed in a vertical position, as shown in FIG. 2.

Horizontally mounted propellers 106 are fixedly mounted and integrated into the wings 102. Unlike the propellers 104, the position of the propellers 106 is fixed, however, those skilled in the art will recognize that the propellers 106 could be modified so that they are pivotable between vertical and horizontal positions. The propellers 106 generate maximum vertical thrust for take-off and landing operations of the aircraft. The propellers 106 may also be referred to herein as lifting propellers.

The propellers 104 and 106, which may also be referred to herein as fans, may be operated by a fully-electric drive. To that end, a battery charging system 108 including a charger, an inverter and a fast-charging battery are positioned within the fuselage of the aircraft for powering the propellers 104 and 106. The fuselage may also be configured to carry one or more passengers.

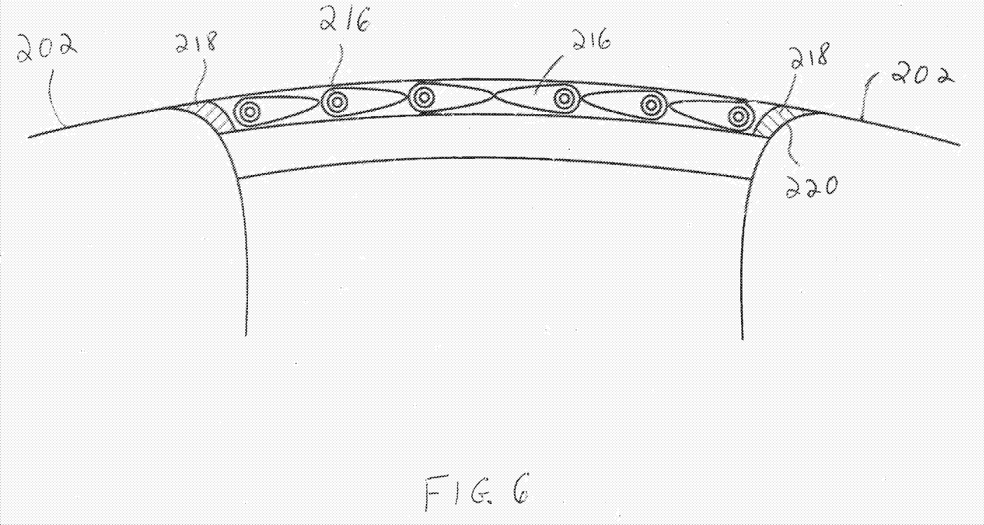

FIGS. 5-7 depict views of an aircraft 200. The aircraft 200 shown in those figures may appear different from the previously described aircraft 100, however, most (if not all) of the details of the previously described aircraft 100 also apply to aircraft 200. Only a segment of the aircraft 200 is shown in FIG. 5. An air duct 210 extends between an opening 212 formed on the nose 214 of the aircraft 200 and the horizontally mounted propeller 206 that is fixedly mounted to the wing 202. In operation, air is delivered to the propeller 206 via the duct 210, as depicts by the arrows. Although not shown, air ducts that are similar to duct 210, may extend to the propeller 206 on the opposite wing 202, as well as any rear propellers 104 (not shown in these views). Accordingly, the propellers may be referred to as either “ducted propellers” or “ducted fans.”

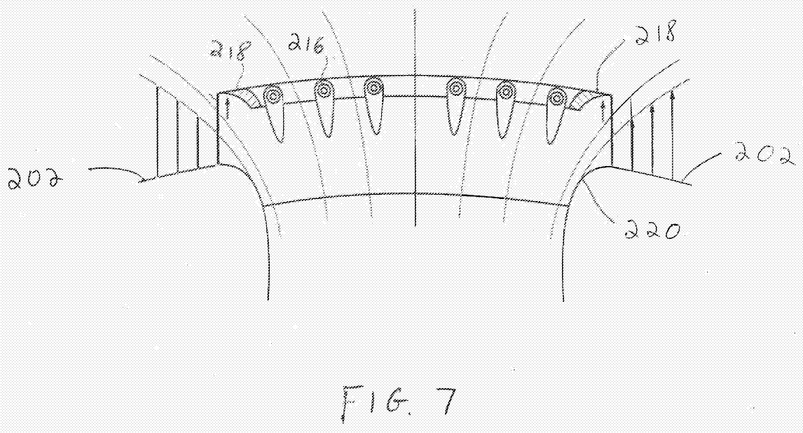

FIGS. 6 and 7 depict louvers 216 that are configured to selectively cover the horizontally mounted propellers 206. It is noted that the louvers 216 are omitted from FIG. 5 for clarity purposes. Each louver 216 is rotatable about a shaft (or otherwise moveable) between a closed position (FIG. 6) and an open position (FIG. 7). The louvers 216, which are flush with the top face of the wing 202, may be moved to the closed position during the cruising operation of the aircraft 200 for aerodynamic purposes. The louvers 216 may be moved to an open position at any time during operation of the propellers 206 to permit the exit or entrance of air therethrough. A motor or solenoid is configured to move the louvers 216 between those positions. It is noted that the louvers are shown in a closed position in FIG. 2.

A sealing ring 218 surrounds the louvers 216 and is moveable between a retracted position (FIG. 6) and a deployed position (FIG. 7). The louvers 216 are mounted to the sealing ring 218 and move therewith between the retracted and deployed positions. The lower surface of the sealing ring 218 is configured to be in sealing relationship with an opening 220 formed in the wing 202. It should be understood that the opening 220 accommodates the body of the propeller 206. The sealing ring 218 may be moved to the retracted position, which is flush with the top face of the wing 202, during cruising operation of the aircraft 200 for aerodynamic purposes. Alternatively, the sealing ring 218 may be moved to the deployed (i.e., extended) position at any time during operation of the propellers 206 to permit the exit or entrance of air, as depicted by the arrows in FIG. 7. A motor or solenoid is configured to move the sealing ring 218 between those positions.

What is claimed is:

1. An aircraft comprising:
cruise propellers, lifting propellers, an energy battery and a power battery,
wherein the energy battery is electrically connected to the cruise propellers and the power battery is electrically connected to the lifting propellers.

2. The aircraft as claimed in claim 1, wherein the aircraft furthermore comprises a reserve battery that is also electrically connected to the lifting propellers.

3. The aircraft as claimed in claim 1, wherein the aircraft furthermore comprises a DC voltage converter that electrically connects the energy battery at least to the power battery.

4. The aircraft as claimed in claim 1, wherein the aircraft has a fully electric drive.

5. The aircraft as claimed in claim 1, wherein the aircraft comprises bent or bendable wings.

6. The aircraft as claimed in claim 1, wherein the aircraft comprises a chargeable battery system.

7. The aircraft as claimed in claim 1, wherein the aircraft comprises horizontally fixed ducted fans for take-off and landing.

8. The aircraft as claimed in claim 7, wherein the aircraft has louvers, and the louvers are configured to selectively cover the horizontal ducted fans.

9. The aircraft as claimed in claim 1, wherein the aircraft comprisesvertically fixed ducted fans for generating a propulsion.

10. The aircraft as claimed in claim 1, wherein the aircraft is configured to be selectively controlled in a fully autonomous manner.
